(19) United States
(12) Patent Application Publication
(10) Pub. No.: US 2019/0287081 A1
(43) Pub. Date: Sep. 19, 2019

(54) METHOD AND DEVICE FOR IMPLEMENTING SERVICE OPERATIONS BASED ON IMAGES

(71) Applicant: Alibaba Group Holding Limited, George Town (KY)

(72) Inventor: Xianlin Lou, Hangzhou (CN)

(73) Assignee: Alibaba Group Holding Limited, George Town (KY)

(21) Appl. No.: 16/432,646

(22) Filed: Jun. 5, 2019

Related U.S. Application Data
(63) Continuation of application No. PCT/CN2017/113490, filed on Nov. 29, 2017.

(30) Foreign Application Priority Data
Dec. 7, 2016 (CN) 201611143094.3

(51) Int. Cl. G06Q 10/00; G06Q 30/02; G06K 9/00

(52) U.S. Cl. CPC G06Q 10/20; G06K 9/00671; G06Q 30/0208

(57) ABSTRACT

This specification describes techniques for implementing service operations based on images. One example method includes receiving an image sharing request sent by a first user, the image sharing request including at least one image to be shared, location information associated with the image, and text information associated with the image; storing the image, the text information, and the location information; identifying a service object based on the location information and the text information; sending an identification of the service object to a second user associated with the first user; receiving a service operation request from the second user including the identification of the service object; and in response to receiving the service operation request, sending service information associated with the service object to the second user, wherein the service information includes operations configured to be executed by a device associated with the second user.

### CROSS-REFERENCE TO RELATED APPLICATIONS

This application is a continuation of PCT Application No. PCT/CN2017/113490, filed on Nov. 29, 2017, which claims priority to Chinese Patent Application No. 201611143094.3, filed on Dec. 7, 2016, and each application is hereby incorporated by reference in its entirety.

### TECHNICAL FIELD

The present application relates to the field of Internet technologies, and in particular, to a method and device for implementing service operations based on images.

### BACKGROUND

With fast development of Internet technologies, the number of users of social apps (Application, application) is sharply increasing, and the number of users chat with relatives and friends, share feelings, share images, share statuses, and so on by using the social apps is also increasing.

### SUMMARY

In view of this, the present application provides a method and device for implementing service operations based on images.

The present application is implemented by using the following technical solutions.

A method for implementing service operations based on images is provided, where the method is applied to a server, and the method includes: after an image sharing request sent by a first user is received, storing attribute information included in the image sharing request, where the attribute information includes first location information of the images and text information entered by the first user when the first user shares the images; searching, based on the first location information and the text information, a database for a service object associated with the images; and pushing the images to a second user associated with the user, and sending information about the service object to the second user based on a predetermined policy.

A method for implementing service operations based on images is provided, where the method is applied to a client, and the method includes: displaying images that are pushed by a server and shared by a first user associated with a current user; when service operations performed by the current user on the images shared by the first user are detected, generating a service operation request for the images; and sending the service operation request to the server, receiving information about a service object associated with the images that is returned by the server, and performing corresponding operations, where the service object is found by searching the database by the server based on first location information and text information of the images, where the text information is entered by the first user when the first user shares the images.

A device for implementing service operations based on images is provided, where the device is applied to a server, and the device includes: a sharing and receiving unit, configured to: after receiving an image sharing request sent by a first user, store attribute information included in the image sharing request, where the attribute information includes first location information of the images and text information entered by the first user when the first user shares the images; an object search unit, configured to search, based on the first location information and the text information, a database for a service object associated with the images; an image pushing unit, configured to push the images to a second user associated with the user; and an object sending unit, configured to send information about the service object to the second user based on a predetermined policy.

A device for implementing service operations based on images is provided, where the device is applied to a client, and the device includes: an image display unit, configured to display images that are pushed by a server and shared by a first user associated with a current user; a request generation unit, configured to: when service operations performed by the current user on the images shared by the first user are detected, generate a service operation request for the images; and an operation execution unit, configured to send the service operation request to the server, receive information about a service object associated with the images that is returned by the server, and perform corresponding operations, where the service object is found by searching the database by the server based on first location information and text information of the images, where the text information is entered by the first user when the first user shares the images.

It can be seen from the previous description that, based on the implementation solutions of the present application, a user can obtain the information about the corresponding service object by using the images shared by the associated user, without a need to redirect to another page. Therefore, the operations are simple and fast, thereby improving use experience of the user.

### BRIEF DESCRIPTION OF DRAWINGS

FIG. 1 is a schematic flowchart illustrating a method for implementing service operations based on images, according to an example implementation of the present application;

FIG. 2 is a schematic flowchart illustrating another method for implementing service operations based on images, according to an example implementation of the present application;

FIG. 3 is a schematic diagram illustrating a client web page, according to an example implementation of the present application;

FIG. 4 is a schematic diagram illustrating a client web page, according to an example implementation of the present application;

FIG. 5 is a schematic diagram illustrating a client web page, according to an example implementation of the present application;

FIG. 6 is a schematic diagram illustrating a client web page, according to an example implementation of the present application;

FIG. 7 is a schematic diagram illustrating a client web page, according to an example implementation of the present application;

FIG. 8 is a schematic structural diagram illustrating a device for implementing service operations based on images, according to an example implementation of the present application;

FIG. 9 is a block diagram illustrating a device for implementing service operations based on images, according to an example implementation of the present application;

FIG. 10 is a block diagram illustrating another device for implementing service operations based on images, according to an example implementation of the present application; and

FIG. 11 is a flowchart illustrating an example of a computer-implemented method for implementing service operations based on images, according to an implementation of the present disclosure.

### DESCRIPTION OF IMPLEMENTATIONS

Example implementations are described in detail here, and examples of the example implementations are presented in the accompanying drawings. When the following description relates to the accompanying drawings, unless specified otherwise, same numbers in different accompanying drawings represent same or similar elements. Implementations described in the following example implementations do not represent all implementations consistent with the present application. Instead, they are only examples of devices and methods consistent with some aspects of the present application that are described in detail in the appended claims.

The terms used in the present application are merely for illustrating specific implementations, and are not intended to limit the present application. The terms “a” and “the” of singular forms used in the present application and the appended claims are also intended to include plural forms, unless otherwise specified in the context clearly. It should be further understood that the term “and/or” used in the present specification indicates and includes any or all possible combinations of one or more associated listed items.

It should be understood that although terms “first”, “second”, “third”, etc. may be used in the present application to describe various types of information, the information is not limited to the terms. These terms are only used to differentiate information of a same type. For example, without departing from the scope of the present application, first information can alternatively be referred to as second information, and similarly, the second information can alternatively be referred to as the first information. Depending on the context, for example, the word “if” used here can be explained as “while”, “when”, or “in response to determining”.

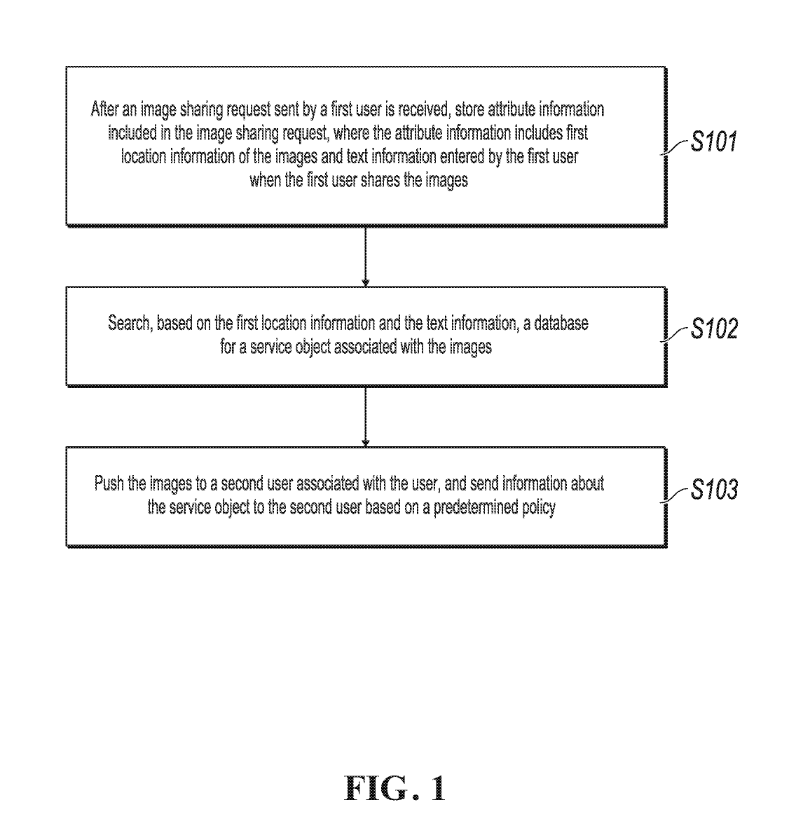

FIG. 1 is a schematic flowchart illustrating a method for implementing service operations based on images, according to an example implementation of the present application.

Referring to FIG. 1, the method for implementing service operations based on images can be applied to a server, for example, a server or a server cluster deployed by a service provider, and the method includes the following steps.

Step 101: After an image sharing request sent by a first user is received, store attribute information included in the image sharing request, where the attribute information includes first location information of the images and text information entered by the first user when the first user shares the images.

In the present implementation, the first user can share the images by using a sharing function provided in a social app. For example, the first user can share the images by using Community of ALIPAY, or the first user can alternatively share the images by using Moments of WeChat. Certainly, in addition to the social app, the user can alternatively share the images by using an app that provides a community function or a forum function. Implementations are not limited in the present application.

Step 102: Search, based on the first location information and the text information, a database for a service object associated with the images.

In the present implementation, the database may be a database that stores location information and information about a corresponding service object, such as a map database, and the service object may include a third-party service organization such as a shop, a school, or a bank.

Step 103: Push the images to a second user associated with the user, and send information about the service object to the second user based on a predetermined policy.

In the present implementation, after receiving the image sharing request sent by the first user, the server may push the images to the second user associated with the first user. The second user may be a friend of the user, a person who follows the user, a person who has performed service interaction with the user, or the like.

In the present implementation, the server may first push, to the second user, a notification that there is new sharing, and when the second user checks the new sharing, the images may then be sent to the second user. For processing and implementation of this part, refer to related technologies. Details are omitted here for simplicity in the present application.

In the present implementation, the predetermined policy may be active sending. For example, the server can send the information about the service object and the images to the second user together. Alternatively, the predetermined policy may be triggered sending. For example, when receiving a service operation request for the images that is sent by the second user, the server can send the information about the service object to the second user.

It is worthwhile to note that interaction processes of the user and the server that are described in the present implementation of the present application, such as an interaction process of sending the image sharing request by the first user to the server and an interaction process of pushing image sharing by the server to the second user, are all interaction processes of the server and a client logged in by the related user using a user account of the user. Details are omitted below for simplicity.

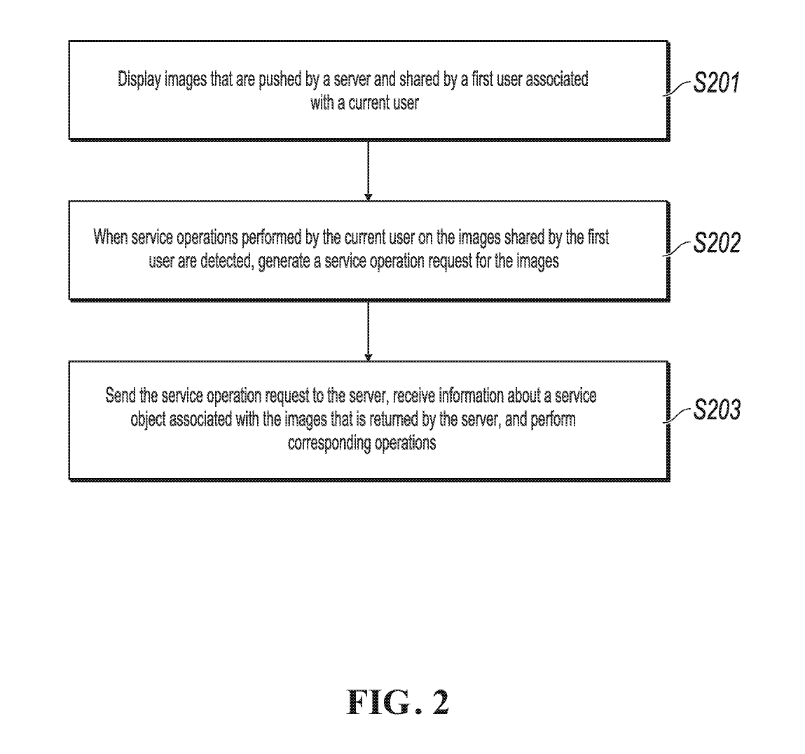

FIG. 2 is a schematic flowchart illustrating another method for implementing service operations based on images, according to an example implementation of the present application.

Referring to FIG. 2, the method for implementing service operations based on images can be applied to a client and includes the following steps.

Step 201: Display images that are pushed by a server and shared by a first user associated with a current user.

Step 202: When service operations performed by the current user on the images shared by the first user are detected, generate a service operation request for the images.

In the present implementation, the current user may select, in a way such as tap or double-touch, the images shared by the first user. The client of the current user can further display one or more service operation options, and the service operation option is oriented to a service object associated with the images. When selecting a certain service operation option, the user can determine that the service operations performed on the images are detected.

Step 203: Send the service operation request to the server, receive information about a service object associated with the images that is returned by the server, and perform corresponding operations.

In the present implementation, after receiving name information and second location information of the service object that are returned by the server, the client of the current user can invoke a map app and locate the service object in the map app. Certainly, in practice, if the client of the current user has a map function, the client can alternatively jump to a map page and locate the service object on the map page.

In the present implementation, after receiving the service information of the service object that is returned by the server, the client of the current user can display the service information, so that the user can check the service information. The service information includes at least one of the following information: an experience service, a contact number, promotion information, discount information, etc.

In the present implementation, after receiving payment information of the service object that is returned by the server, the client of the current user can jump to a payment page oriented to the service object, so that the user completes a payment operation. Certainly, in practice, if the client of the current user does not have a payment function, another payment app may alternatively be invoked. Implementations are not limited in the present application.

It can be seen from the previous description that, based on the implementation solutions of the present application, the user can implement operations on the corresponding service object such as location, service search, and payment by using the images shared by the associated user, without a need to redirect to another page. Therefore, the operations are simple and fast, thereby improving use experience of the user.

The following describes the technical solutions of the present application in detail by using three phases: publishing of image sharing, searching of an associated service object, and implementation of service operations.

I. Publishing of Image Sharing

In the present implementation, the Community of ALIPAY is used as an example, and the user can share images of food, scenery, etc. in the Community. For ease of differentiation, the user who shares the images may be referred to as the first user. When the first user selects a “record life” function of ALIPAY, an image that needs to be shared may be added. For example, a camera may be invoked to take a photo or a photo may be selected from photo libraries. After the first user adds an image, the client (ALIPAY) can obtain attribute information of current image sharing. The attribute information can generally include location coordinates (first location information) of the image and text information entered when the first user shares the image. The location coordinates of the image are generally obtained and stored by the terminal device when the image is being taken. In this example, when the user selects sending, the client may add the obtained first location information, text information, etc. to the image sharing request and send the image sharing request to the server.

In the present implementation, after receiving the image sharing request, the server can generate a unique image ID for the image, and store a mapping relationship between the attribute information and the image ID.

Assume that the first user White shares an image of a kebab in the Community, location coordinates of the image are coordinates 1, and text information is “kebabs here are really delicious”. The server generates an image ID 1 for the corresponding image, and the server can store a mapping relationship between the attribute information and the image ID in the following table. It is worthwhile to note that Table 1 is merely an example for description. In practice, the server may not organize such a table. Implementations are not limited in the present application.

TABLE 1

| Image | Location coordinates | Text |
|---|---|---|
| ID | of an image | information |
| 1 | Coordinates 1 | Kebabs here are really delicious |
| 2 | Coordinates 2 | Beautiful! |
| 3 | Coordinates 3 | Superb film |

In the present implementation, the server can add the image ID 1 of the image to image sharing of White and push the image sharing of White to a friend of White, and the friend of White can check the sharing by using the Community of ALIPAY.

II. Searching of an Associated Service Object

In the present implementation, after receiving the image sharing request sent by White, the server can search, based on the first location information and the text information that are included in the image sharing request, the database for the service object associated with the image. The database may be a service object database of this platform, or the database may alternatively be a database provided by another platform, for example, a certain map database. Implementations are not limited in the present application.

In the present implementation, because an error may occur during GPS positioning, the location coordinates (first location information) obtained by the terminal device when the terminal device takes the image may not be accurate enough. The server can identify a plurality of matching shops based on the first location information. For example, the server can identify “Alibaba Kebabs” and “Cleanness Dry Cleaner”. In such a case, the server can separately match, against information of “Alibaba Kebabs” and information of “Cleanness Dry Cleaner”, the text information of “kebabs here are really delicious” that is sent by White. For example, the text information is divided into words, and the words are separately matched against the information of “Alibaba Kebabs” and the information of “Cleanness Dry Cleaner”. In this example, the server can identify that “kebabs” in the text information matches services of “Alibaba Kebabs”, and can further determine “Alibaba Kebabs” as a shop associated with the image. Certainly, in practice, the text information can alternatively be matched against the service object in another method. Generally, a most matching service object can be determined as the service object associated with the image.

In the present implementation, after receiving the image sharing request sent by White, the server can search for the shop associated with the image shared by White, and store a mapping relationship between the image ID 1 of the image, the found shop, and the accurate location coordinates (second location information) of the shop. The server may alternatively search for the shop after receiving a service operation request for the shop. Implementations are not limited in the present application.

III. Implementation of Service Operations

In the present implementation, assume that Black (the second user) is the friend of White. After receiving the image that is pushed by the server and shared by White, a client (ALIPAY) of Black can store the image ID 1 of the image. For example, the client can associate the image ID 1 with the image shared by White and store the image ID 1 and the image.

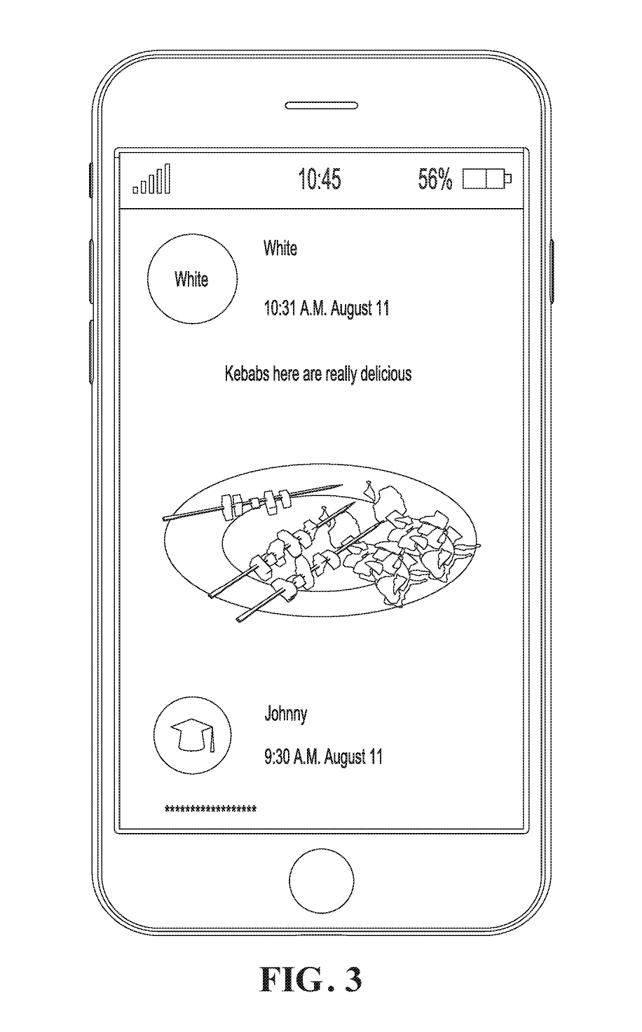

FIG. 3 shows a Community page that can be displayed by the client of Black.

Assume that after noticing the image, Black wants to know where White gets the kebabs. In this example, Black does not need to redirect to a chat page to send a message to White, or need to ask White by using Comment in the Community. Black can tap the image, and the client can display one or more service operation options for Black, so that Black can make a selection.

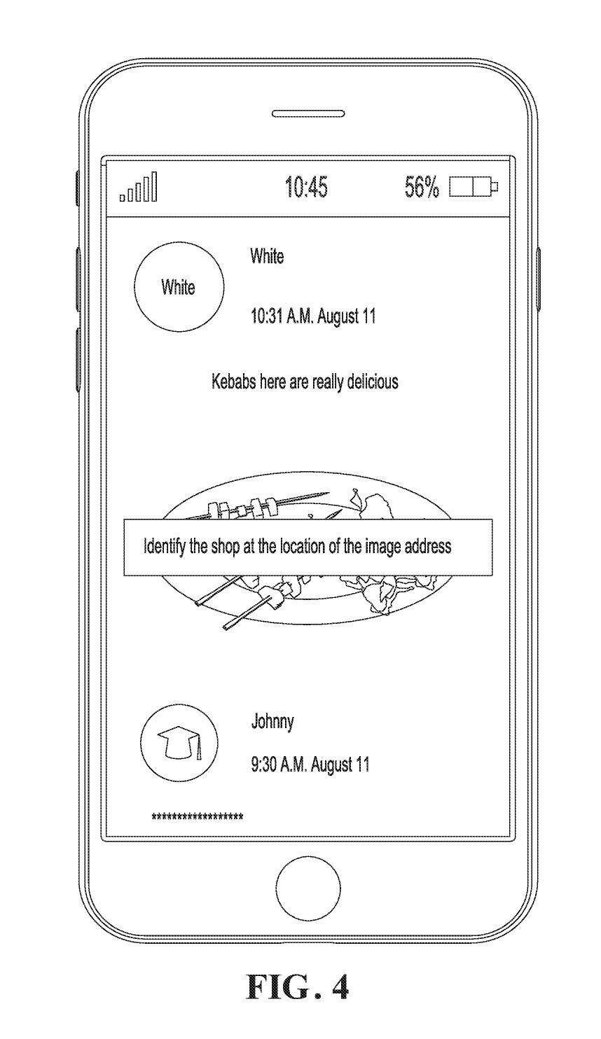

In an example, referring to FIG. 4, after Black taps the image, the client can display the service operation option shown in FIG. 4. When Black selects the operation option, the client can send the image ID 1 of the image to the server. The server can further identify a shop corresponding to the image ID 1.

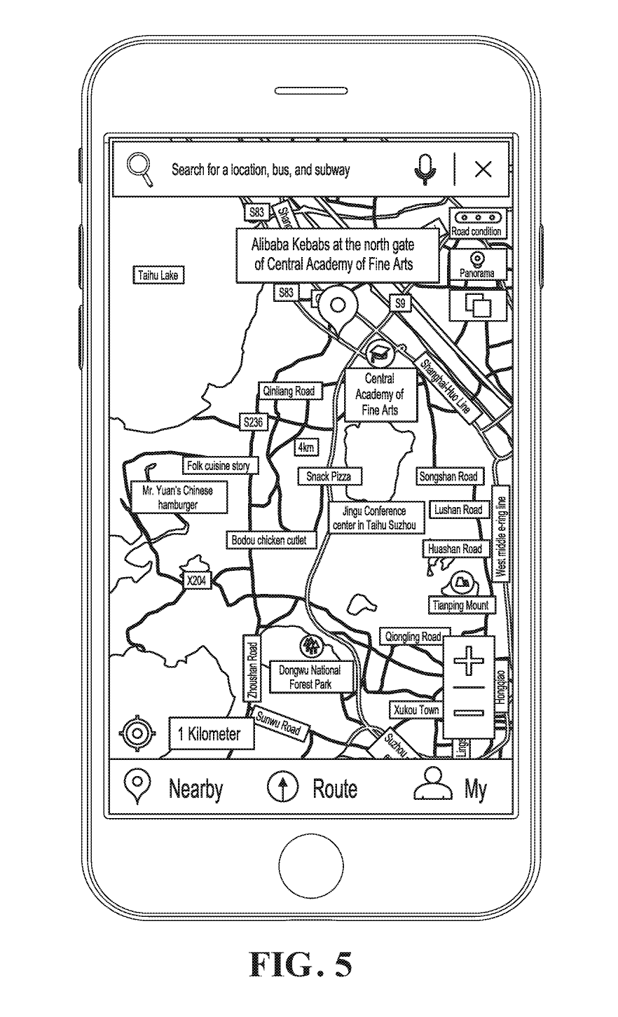

In the present implementation, “identify the shop at the location of the image address” corresponds to an identification request of the service object. After finding a matching shop, the server can return a name and accurate location coordinates of the shop to the client of Black. After receiving the name and the accurate location coordinates, the client of Black can invoke the Amap app to locate the shop in the Amap app, and further display a page shown in FIG. 5. Black can search for information such as a route to the shop by using the page shown in FIG. 5.

Certainly, in practice, after finding the matching shop, the server may alternatively return only the name of the shop to the client of Black, so that the client of Black can display the name of the shop.

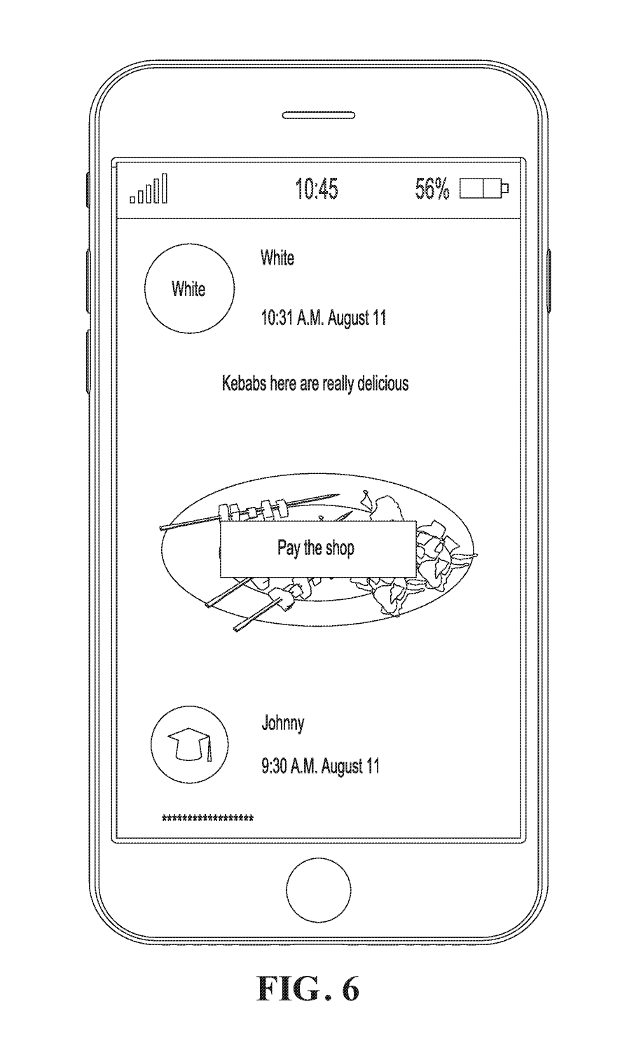

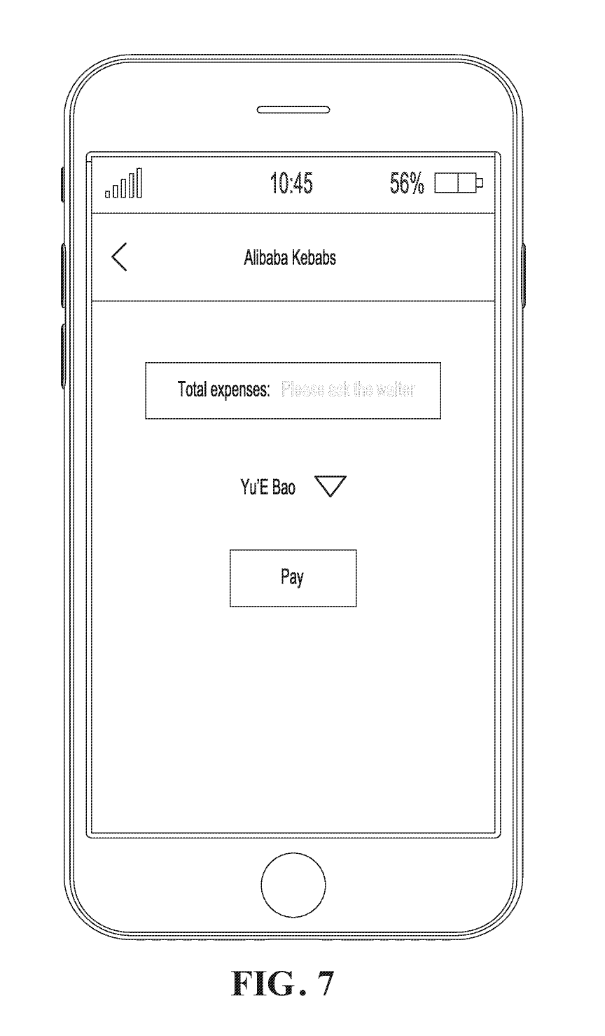

In another example, referring to FIG. 6, after Black taps the image, the client may display a service operation option shown in FIG. 6. “Payment to the shop” corresponds to a payment request oriented to the service object. After finding a matching shop, the server may return payment information of the shop to the client of Black. After receiving the payment information, the client of Black may jump to a payment page oriented to the shop, for example, the client of Black may display a page shown in FIG. 7. Black can pay the shop by using the page shown in FIG. 7.

In another example, after Black taps the image, the client may alternatively display a search request oriented to the service object, for example, the client may display a service operation option (not shown) of “check information about the shop”. After finding the matching shop, the server may return service information of the shop to the client of Black, so that the client of Black displays the service information. The service information may include at least one of the following information: an experience service, a contact number, promotion information, discount information, etc.

In another example, after Black taps the image, the client may alternatively display a plurality of service operation options at the same time, and Black may make a selection based on needs of Black.

In another example, the server may send, to Black, both information about the matching shop and the image shared by White. After receiving the image and the information about the shop, the client of Black may display, based on a predetermined display rule, the matching shop while displaying the image shared by White, without needing a manual request of Black.

Based on the previous implementation solutions, after White adds the image and the text information, the client of White may send the first location information and the text information of the image to the server, and the server searches for a corresponding shop and may return the shop to the client. As such, when White selects shared locations, the client may rank, in the first place, the shop found by the server, or automatically add the shop to locations shared by White, so that White does not need to repeatedly search the plurality of locations, thereby improving locating accuracy and improving use experience of the user.

Corresponding to the previous implementation of the methods for implementing service operations based on images, the present application further provides an implementation of a device for implementing service operations based on images.

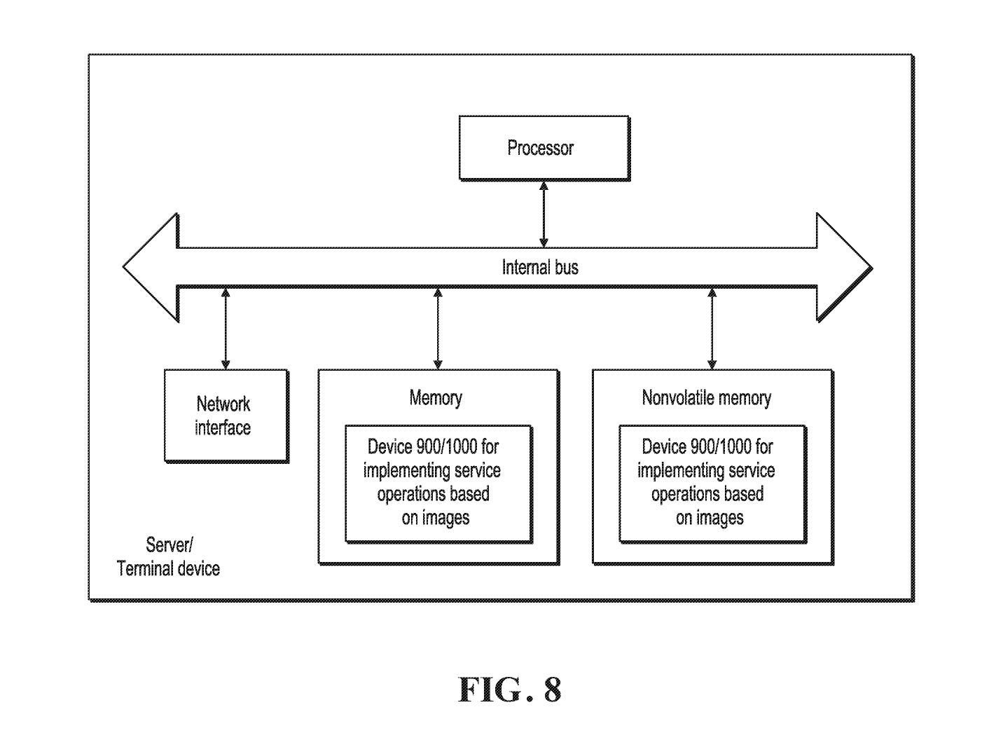

Implementations of the device for implementing service operations based on images in the present application may be separately applied to a client mounted on the terminal device or to a server. The apparatus implementation can be implemented by software, hardware, or a combination of hardware and software. Software implementation is used as an example. As a logical device, the device is formed by reading a corresponding computer program instruction in a non-volatile memory into the memory by a processor of the terminal device or the server where the device is located. From a perspective of hardware, FIG. 8 is a structural diagram illustrating hardware of a terminal device or a server where a device for implementing service operations based on images in the present application is located. In addition to a processor, a memory, a network interface, and a non-volatile memory shown in FIG. 8, the terminal device or the server where the device in the present implementation is located can usually include other hardware based on actual functions of the terminal device or the server. Details are omitted here for simplicity.

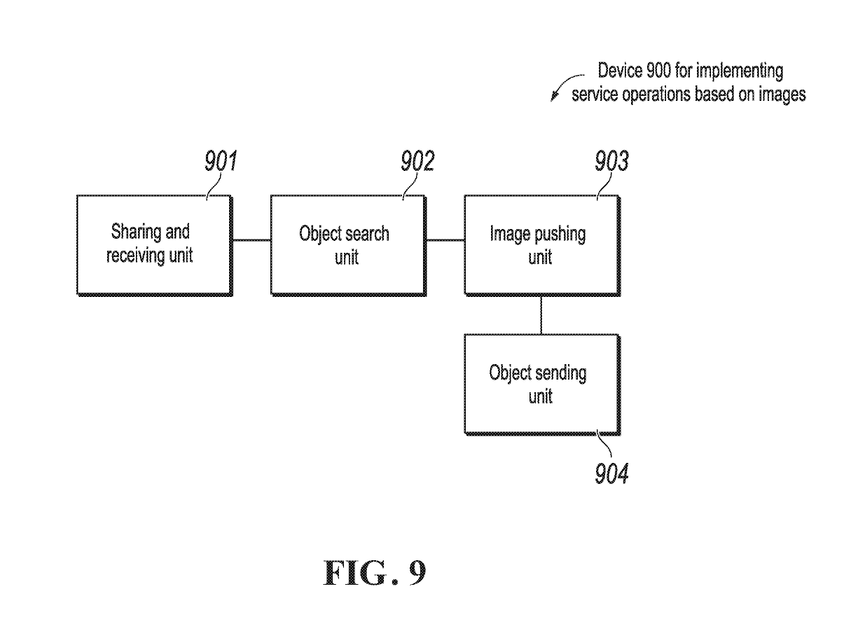

FIG. 9 is a block diagram illustrating a device for implementing service operations based on images, according to an example implementation of the present application.

Referring to FIG. 9, a device 900 for implementing service operations based on images may be applied to the previous server shown in FIG. 8, and includes a sharing and receiving unit 901, an object search unit 902, an image pushing unit 903, and an object sending unit 904.

The sharing and receiving unit 901 is configured to: after receiving an image sharing request sent by a first user, store attribute information included in the image sharing request, where the attribute information includes first location information of the images and text information entered by the first user when the first user shares the images.

The object search unit 902 is configured to search, based on the first location information and the text information, a database for a service object associated with the images.

The image pushing unit 903 is configured to push the images to a second user associated with the user.

The object sending unit 904 is configured to send information about the service object to the second user based on a predetermined policy.

Optionally, the object sending unit 904 is configured to: when a service operation request for the images that is sent by the second user is received, send the information about the service object to the second user.

Optionally, the object sending unit 904 is configured to: when the service operation request is an identification request of the service object, send name information of the service object to the second user.

Optionally, the object sending unit 904 is configured to: when the service operation request is an identification request of the service object, send second location information of the service object in the database to the second user, so that a client of the second user invokes a map app and locates the service object in the map app.

Optionally, the object sending unit 904 is configured to: when the service operation request is a service search request of the service object, send service information of the service object to the second user, so that the second user can check the service information.

Optionally, the service information includes at least one of the following information: an experience service, a contact number, promotion information, and discount information.

Optionally, the object sending unit 904 is configured to: when the service operation request is a payment request, send payment information of the service object to the second user, so that a client of the second user jumps to a payment page oriented to the service object.

Optionally, the object sending unit 904 is configured to send the information about the service object and the images to the second user together.

Optionally, the object search unit 902 is configured to: search the database for a service object that matches the first location information; when a plurality of service objects are found, match the text information against information about each found service object; and determine that a service object whose matching result satisfies a predetermined requirement is the service object that is associated with the images.

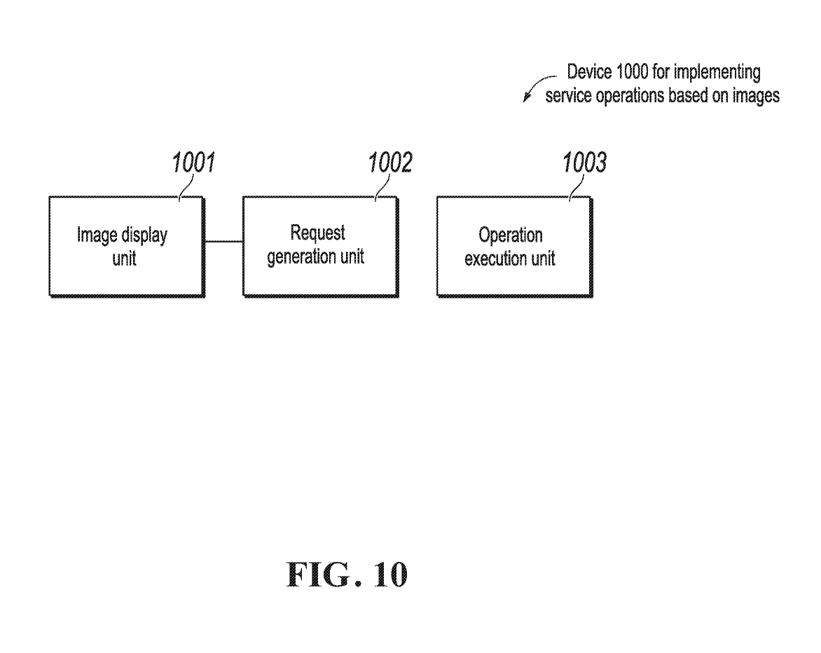

FIG. 10 is a block diagram illustrating another device for implementing service operations based on images, according to an example implementation of the present application.

Referring to FIG. 10, a device 1000 for implementing service operations based on images may be applied to the terminal device shown in FIG. 8, and includes an image display unit 1001, a request generation unit 1002, and an operation execution unit 1003.

The image display unit 1001 is configured to display images that are pushed by a server and shared by a first user associated with a current user.

The request generation unit 1002 is configured to: when service operations performed by the current user on the images shared by the first user are detected, generate a service operation request for the images.

The operation execution unit 1003 is configured to send the service operation request to the server, receive information about a service object associated with the images that is returned by the server, and perform corresponding operations.

The service object is found by searching the database by the server based on first location information and text information of the images, where the text information is entered by the first user when the first user shares the images.

Optionally, the request generation unit 1002 is configured to: when predetermined operations performed by the current user on the images shared by the first user are detected, display one or more service operation options, and if the current user selects the service operation option, determine that the service operations performed on the images shared by the first user are detected.

Optionally, the operation execution unit 1003 is configured to: when the service operation request is an identification request of the service object, receive second location information of the service object that is returned by the server; and invoke a map app, and locate the service object in the map app based on the second location information.

Optionally, the operation execution unit 1003 is configured to: when the service operation request is a service search request of the service object, receive service information of the service object that is returned by the server and display the service information.

Optionally, the service information includes at least one of the following information: an experience service, a contact number, promotion information, and discount information.

Optionally, the operation execution unit 1003 is configured to: when the service operation request is a payment request, receive payment information of the service object that is returned by the server, and jump, based on the payment information, to a payment page oriented to the service object.

For an implementation process of functions and roles of each unit in the device, references can be made to an implementation process of corresponding steps in the previous method. Details are omitted here for simplicity.

Because an apparatus implementation basically corresponds to a method implementation, for related parts, references can be made to related descriptions in the method implementation. The previously described apparatus implementation is merely an example. The units described as separate parts may or may not be physically separate, and parts displayed as units may or may not be physical units, may be located in one position, or may be distributed on a plurality of network units. Some or all of the modules or units can be selected based on actual needs to achieve the objectives of the solutions in the present application. A person of ordinary skill in the art can understand and implement the implementations of the present specification without creative efforts.

The system, device, module, or unit illustrated in the previous implementations can be implemented by using a computer chip or an entity, or can be implemented by using a product having a certain function. A typical implementation device is a computer, and the computer can be a personal computer, a laptop computer, a cellular phone, a camera phone, a smartphone, a personal digital assistant, a media player, a navigation device, an email receiving and sending device, a game console, a tablet computer, a wearable device, or any combination of these devices.

The previous descriptions are merely examples of implementations of the present application, but are not intended to limit the present application. Any modification, equivalent replacement, or improvement made without departing from the spirit and principle of the present application should fall within the protection scope of the present application.

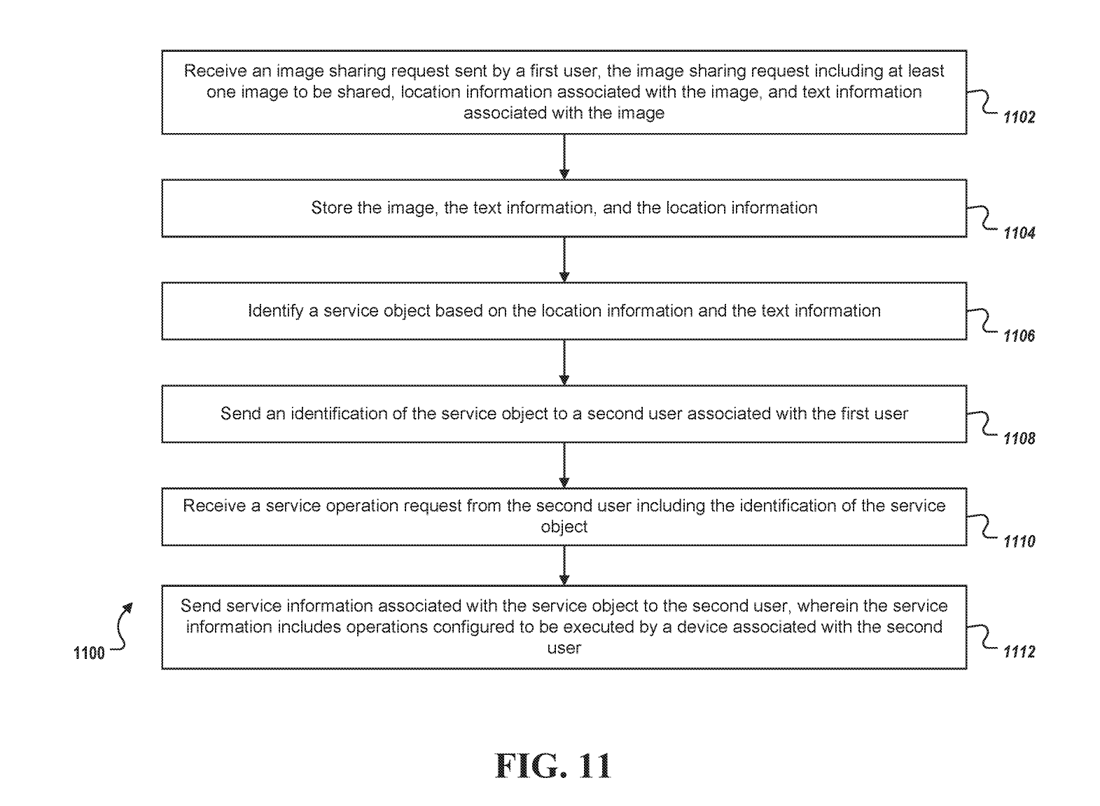

FIG. 11 is a flowchart illustrating an example of a computer-implemented method 1100 for implementing service operations based on images according to an implementation of the present disclosure. For clarity of presentation, the description that follows generally describes method 1100 in the context of the other figures in this description. However, it will be understood that method 1100 can be performed, for example, by any system, environment, software, and hardware, or a combination of systems, environments, software, and hardware, as appropriate. In some implementations, various steps of method 1100 can be run in parallel, in combination, in loops, or in any order.

At 1102, an image sharing request sent by a first user is received, the image sharing request including at least one image to be shared, location information associated with the image, and text information associated with the image;

At 1104, the image, the text information, and the location information are stored.

At 1106, a service object is identified based on the location information and the text information;

At 1108, an identification of the service object is sent to a second user associated with the first user. In some cases, sending the identification of the service object is performed based on a predetermined policy. In some cases, the service operation request is an identification request of the service object. In some implementations, sending the identification of the service object to the second user includes sending name information of the service object to the second user. In some cases, sending the service information associated with the service object to the second user comprises: sending a location of the service object to the second user, so that a client of the second user invokes a map app and locates the service object based on the location in the map app.

At 1110, a service operation request is received from the second user including the identification of the service object. In some cases, the service operation request comprises a payment request and sending the service information to the second user comprises: sending payment information to the second user, wherein the payment information is configured to cause the device of the second user to retrieve a payment page associated with the service object.

At 1112, in response to receiving the service operation request, service information associated with the service object is sent to the second user, wherein the service information includes operations configured to be executed by a device associated with the second user. In some cases, the service information comprises at least one of the following information: an experience service, a contact number, promotion information, or discount information.

The techniques described in this specification produce one or more technical effects. For example, the techniques allow a shared image to be displayed or processed by a client device according to service operations selected based on text information (e.g., keywords) and location information provided by the sharing user. This allows sharing user and the system facilitating the sharing to exhibit greater control over the presentation of the shared image on other clients. In addition, the present techniques allow greater customizability of this presentation by providing the devices with instructions to be executed when displaying the shared image. This allows the behavior of the device to be changed without requiring a change to the application on the device that displays the image.

Embodiments and the operations described in this specification can be implemented in digital electronic circuitry, or in computer software, firmware, or hardware, including the structures disclosed in this specification or in combinations of one or more of them. The operations can be implemented as operations performed by a data processing apparatus on data stored on one or more computer-readable storage devices or received from other sources. A data processing apparatus, computer, or computing device may encompass apparatus, devices, and machines for processing data, including by way of example a programmable processor, a computer, a system on a chip, or multiple ones, or combinations, of the foregoing. The apparatus can include special purpose logic circuitry, for example, a central processing unit (CPU), a field programmable gate array (FPGA) or an application-specific integrated circuit (ASIC). The apparatus can also include code that creates an execution environment for the computer program in question, for example, code that constitutes processor firmware, a protocol stack, a database management system, an operating system (for example an operating system or a combination of operating systems), a cross-platform runtime environment, a virtual machine, or a combination of one or more of them. The apparatus and execution environment can realize various different computing model infrastructures, such as web services, distributed computing and grid computing infrastructures.

A computer program (also known, for example, as a program, software, software application, software module, software unit, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A program can be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program can be executed on one computer or on multiple computers that are located at one site or distributed across multiple sites and interconnected by a communication network.

Processors for execution of a computer program include, by way of example, both general- and special-purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data. A computer can be embedded in another device, for example, a mobile device, a personal digital assistant (PDA), a game console, a Global Positioning System (GPS) receiver, or a portable storage device. Devices suitable for storing computer program instructions and data include non-volatile memory, media and memory devices, including, by way of example, semiconductor memory devices, magnetic disks, and magneto-optical disks. The processor and the memory can be supplemented by, or incorporated in, special-purpose logic circuitry.

Mobile devices can include handsets, user equipment (UE), mobile telephones (for example, smartphones), tablets, wearable devices (for example, smart watches and smart eyeglasses), implanted devices within the human body (for example, biosensors, cochlear implants), or other types of mobile devices. The mobile devices can communicate wirelessly (for example, using radio frequency (RF) signals) to various communication networks (described below). The mobile devices can include sensors for determining characteristics of the mobile device's current environment. The sensors can include cameras, microphones, proximity sensors, GPS sensors, motion sensors, accelerometers, ambient light sensors, moisture sensors, gyroscopes, compasses, barometers, fingerprint sensors, facial recognition systems, RF sensors (for example, Wi-Fi and cellular radios), thermal sensors, or other types of sensors. For example, the cameras can include a forward- or rear-facing camera with movable or fixed lenses, a flash, an image sensor, and an image processor. The camera can be a megapixel camera capable of capturing details for facial and/or iris recognition. The camera along with a data processor and authentication information stored in memory or accessed remotely can form a facial recognition system. The facial recognition system or one-or-more sensors, for example, microphones, motion sensors, accelerometers, GPS sensors, or RF sensors, can be used for user authentication.

To provide for interaction with a user, embodiments can be implemented on a computer having a display device and an input device, for example, a liquid crystal display (LCD) or organic light-emitting diode (OLED)/virtual-reality (VR)/augmented-reality (AR) display for displaying information to the user and a touchscreen, keyboard, and a pointing device by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments can be implemented using computing devices interconnected by any form or medium of wireline or wireless digital data communication (or combination thereof), for example, a communication network. Examples of interconnected devices are a client and a server generally remote from each other that typically interact through a communication network. A client, for example, a mobile device, can carry out transactions itself, with a server, or through a server, for example, performing buy, sell, pay, give, send, or loan transactions, or authorizing the same. Such transactions may be in real time such that an action and a response are temporally proximate; for example an individual perceives the action and the response occurring substantially simultaneously, the time difference for a response following the individual's action is less than 1 millisecond (ms) or less than 1 second (s), or the response is without intentional delay taking into account processing limitations of the system.

Examples of communication networks include a local area network (LAN), a radio access network (RAN), a metropolitan area network (MAN), and a wide area network (WAN). The communication network can include all or a portion of the Internet, another communication network, or a combination of communication networks. Information can be transmitted on the communication network according to various protocols and standards, including Long Term Evolution (LTE), 5G, IEEE 802, Internet Protocol (IP), or other protocols or combinations of protocols. The communication network can transmit voice, video, biometric, or authentication data, or other information between the connected computing devices.

Features described as separate implementations may be implemented, in combination, in a single implementation, while features described as a single implementation may be implemented in multiple implementations, separately, or in any suitable sub-combination. Operations described and claimed in a particular order should not be understood as requiring that the particular order, nor that all illustrated operations must be performed (some operations can be optional). As appropriate, multitasking or parallel-processing (or a combination of multitasking and parallel-processing) can be performed.

1. A computer-implemented method for implementing service operations based on images, the method comprising:
receiving an image sharing request sent by a first user, the image sharing request including at least one image to be shared, location information associated with the image, and text information associated with the image;
storing the image, the text information, and the location information;
identifying a service object based on the location information and the text information;
sending an identification of the service object to a second user associated with the first user;
receiving a service operation request from the second user including the identification of the service object; and
in response to receiving the service operation request, sending service information associated with the service object to the second user, wherein the service information includes operations configured to be executed by a device associated with the second user.

2. The method according to claim 1, wherein sending the identification of the service object is performed based on a predetermined policy.

3. The method according to claim 2, wherein the service operation request is an identification request of the service object.

4. The method according to claim 1, wherein sending the identification of the service object to the second user comprises:
sending name information of the service object to the second user.

5. The method according to claim 1, wherein sending the service information associated with the service object to the second user comprises:
sending a location of the service object to the second user, so that a client of the second user invokes a map app and locates the service object based on the location in the map app.

6. The method according to claim 1, wherein the service information comprises at least one of the following information: an experience service, a contact number, promotion information, or discount information.

7. The method according to claim 1, wherein the service operation request comprises a payment request and sending the service information to the second user comprises:
sending payment information to the second user, wherein the payment information is configured to cause the device of the second user to retrieve a payment page associated with the service object.

8. A non-transitory, computer-readable medium storing one or more instructions executable by a computer system to perform operations comprising:
receiving an image sharing request sent by a first user, the image sharing request including at least one image to be shared, location information associated with the image, and text information associated with the image;
storing the image, the text information, and the location information;
identifying a service object based on the location information and the text information;
sending an identification of the service object to a second user associated with the first user;
receiving a service operation request from the second user including the identification of the service object; and
in response to receiving the service operation request, sending service information associated with the service object to the second user, wherein the service information includes operations configured to be executed by a device associated with the second user.

9. The non-transitory, computer-readable medium according to claim 8, wherein sending the identification of the service object is performed based on a predetermined policy.

10. The non-transitory, computer-readable medium according to claim 9, wherein the service operation request is an identification request of the service object.

11. The non-transitory, computer-readable medium according to claim 8, wherein sending the identification of the service object to the second user comprises:
sending name information of the service object to the second user.

12. The non-transitory, computer-readable medium according to claim 8, wherein sending the service information associated with the service object to the second user comprises:
sending a location of the service object to the second user, so that a client of the second user invokes a map app and locates the service object based on the location in the map app.

13. The non-transitory, computer-readable medium according to claim 8, wherein the service information comprises at least one of the following information: an experience service, a contact number, promotion information, or discount information.

14. The non-transitory, computer-readable medium according to claim 8, wherein the service operation request comprises a payment request and sending the service information to the second user comprises:
sending payment information to the second user, wherein the payment information is configured to cause the device of the second user to retrieve a payment page associated with the service object.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving an image sharing request sent by a first user, the image sharing request including at least one image to be shared, location information associated with the image, and text information associated with the image;
storing the image, the text information, and the location information;
identifying a service object based on the location information and the text information;
sending an identification of the service object to a second user associated with the first user;
receiving a service operation request from the second user including the identification of the service object; and
in response to receiving the service operation request, sending service information associated with the service object to the second user, wherein the service information includes operations configured to be executed by a device associated with the second user.

16. The system according to claim 15, wherein sending the identification of the service object is performed based on a predetermined policy.

17. The system according to claim 16, wherein the service operation request is an identification request of the service object.

18. The system according to claim 15, wherein sending the identification of the service object to the second user comprises:
sending name information of the service object to the second user.

19. The system according to claim 15, wherein sending the service information associated with the service object to the second user comprises:
sending a location of the service object to the second user, so that a client of the second user invokes a map app and locates the service object based on the location in the map app.

20. The system according to claim 15, wherein the service information comprises at least one of the following information: an experience service, a contact number, promotion information, or discount information.
